(19) United States
(12) Patent Application Publication
(10) Pub. No.: US 2018/0160016 A1
(43) Pub. Date: Jun. 7, 2018

(54) CAMERA COVER AND IMAGING SYSTEM INCLUDING THE SAME

(71) Applicant: KAWASAKI JUKOGYO KABUSHIKI KAISHA, Kobe-shi, Hyogo (JP)

(72) Inventors: Hideshi YAMANE, Kakogawa-shi (JP); Jun TAKEBAYASHI, Kakogawa-shi (JP); Shuhei KURAOKA, Akashi-shi (JP); Tatsuhiro UTO, Akashi-shi (JP); Shinichi FUJISAWA, Ashiya-shi (JP); Hiroyuki MIZUMOTO, Kobe-shi (JP)

(73) Assignee: KAWASAKI JUKOGYO KABUSHIKI KAISHA, Kobe-shi, Hyogo (JP)

(21) Appl. No.: 15/576,312

(22) PCT Filed: May 16, 2016
(86) PCT No.: PCT/JP2016/002384

§ 371 Date: Nov. 22, 2017

(30) Foreign Application Priority Data
May 22, 2015 (JP) 2015-104850

(51) Int. Cl. H04N 5/217; H04N 5/225; B25J 19/04; B08B 5/02; B08B 17/04

(52) U.S. Cl. CPC H04N 5/2171; H04N 5/2254; H04N 5/2252; Y10S 901/15; B08B 5/02; B08B 17/04; Y10S 901/31; B25J 19/04

(57) ABSTRACT

A camera cover configured to accommodates a camera lens is provided, which includes a case having an opening that opens upwardly, a lid body attached to the case, a lid body moving mechanism configured to move the lid body between an open position at which the opening is opened and a closed position at which the opening is closed, an air blow-off part provided in the case and configured to blow off air upwardly when the lid body is at the open position, and an air channel configured to lead air from an air supply source disposed outside the case to the air blow-off part.

### TECHNICAL FIELD

The present disclosure relates to a camera cover and an imaging system including the same.

### BACKGROUND ART

Generally, cameras are furnished in a production field where products are manufactured, to image components, products, etc. (hereinafter, referred to as “the workpiece”). It is known that, for example, assemblies of the components and inspections of products are conducted based on image information acquired from the cameras.

For example, Patent Document 1 discloses that a workpiece on a work table is imaged by a camera installed above the work table, and a given work is performed to the workpiece based on data of the position and posture of the workpiece acquired from the image information.

### REFERENCE DOCUMENT OF CONVENTIONAL ART

### Patent Document

[Patent Document 1] JP2014-176937A

### DESCRIPTION OF THE DISCLOSURE

### Problem to be Solved by the Disclosure

The camera furnished in such a production field is normally installed so that falling dust etc. does not adhere onto a lens of the camera. That is, the camera is installed so that the lens does not face upwardly (for example, facing down or facing sideways). However, it may be desirable in terms of a space-saving efficiency and shortening of time requited for imaging that the camera is installed below the workpiece so that the lens faces upwardly (including an obliquely upward direction).

Therefore, one purpose of the present disclosure is to provide a camera cover and an imaging system including the same, which prevent that dust etc. is adhered onto a lens of the camera, even if the camera is arranged so that the camera lens faces upwardly.

### SUMMARY OF THE DISCLOSURE

In order to solve the above problem, according to one aspect of the present disclosure, a camera cover configured to accommodate a camera lens is provided, which includes a case having an opening that opens upwardly, a lid body attached to the case, a lid body moving mechanism configured to move the lid body between an open position at which the opening is opened and a closed position at which the opening is closed, an air blow-off part provided in the case and configured to blow off air upwardly when the lid body is at the open position, and an air channel configured to lead air from an air supply source disposed outside the case to the air blow-off part. Here, the “upward” includes not only the vertically upward but also the obliquely upward.

According to this structure, since the lid body prevents dust etc. from entering into the case through the opening when the lid body is at the closed position, the dust etc. adhering onto the camera lens accommodated in the camera cover is prevented. In addition, when the lid body is at the open position, air is blown off upwardly from the air blow-off part, i.e., from the inside of the case toward the opening of the easel. Thus, even if the opening is opened, the air blowing off from the air blow-off part prevents dust etc. from entering into the case and adhering onto the camera lens.

In the camera cover, the lid body may be rotatably attached to the case. The lid body moving mechanism may be an air cylinder configured to move the lid body by being supplied with air, from one of the open position and the closed position to the other position. According to this structure, the opening-and-closing operation of the lid body is achieved by a simple mechanism.

The camera cover may include a control valve provided to the air channel and configured to control supply of air from the air supply source to the air blow-off part, and a branched channel that is branched from the air channel at a position downstream of the control valve and leads air to the lid body moving mechanism. The lid body moving mechanism may be an air cylinder, the air cylinder being supplied with air through the branched channel when the control valve is controlled to start supply of air to the air blow-off part, and moving the lid body from the closed position to the open position, while the supply of air to the air cylinder through the branched channel being stopped when the control valve is controlled to stop the supply of air to the air blow-off part, and the air cylinder moving the lid body from the open position to the closed position. According to this structure, by controlling the control valve, the blow-off of air from the air blow-off part and the opening-and-closing operation of the lid body by the lid body moving mechanism are interlocked. Therefore, the blow-off of air from the air blow-off part when the lid body is at the open position is achieved by the simple mechanism,

According to one aspect of the present disclosure, an imaging system is provided, which includes the camera cover described above and a camera unit having the camera lens accommodated in the camera cover, and configured to image a workpiece located above the camera cover when the lid body is at the open position.

The imaging system may further include an articulated robot configured to grip the workpiece. According to this structure, since it is possible to image the workpiece while gripping it by the articulated robot, and the camera cover is located below the workpiece, the articulated robot does not need to avoid the camera cover during the work. Thus, the work time of the articulated robot is shortened,

In the imaging system, the camera cover may be disposed outside an operating range of the articulated robot. According to this structure, the articulated robot is certainly prevented from contacting the camera cover.

### Effect of the Disclosure

According to the present disclosure, a camera cover and an imaging system including the same are provided, which prevent that dust etc. is adhered onto a lens of the camera, even if the camera is arranged so that the camera lens faces upwardly.

### BRIEF DESCRIPTION OF DRAWINGS

FIG. 1 is a structural view schematically illustrating an imaging system provided with a camera cover according to one embodiment of the present disclosure.

FIG. 2 is a partial front view of the camera cover illustrated in FIG. 1 where a state in which a lid body of the camera cover is at a closed position is illustrated.

FIG. 3 is a partial right side view of the camera cover illustrated in FIG. 1.

FIG. 4 is a partial plan view of the camera cover illustrated in FIG. 1.

FIG. 5 is a partial rear view of the camera cover illustrated in FIG. 1.

FIG. 6 is a view illustrating a state where the lid body of the camera cover illustrated in FIG. 1 is at an open position.

FIG. 7 is a partial schematic cross-sectional view of the camera cover illustrated in FIG. 1.

FIG. 8 is an air circuit diagram illustrating a flow of air in the camera cover illustrated in FIG. 1.

### MODE FOR CARRYING OUT THE DISCLOSURE

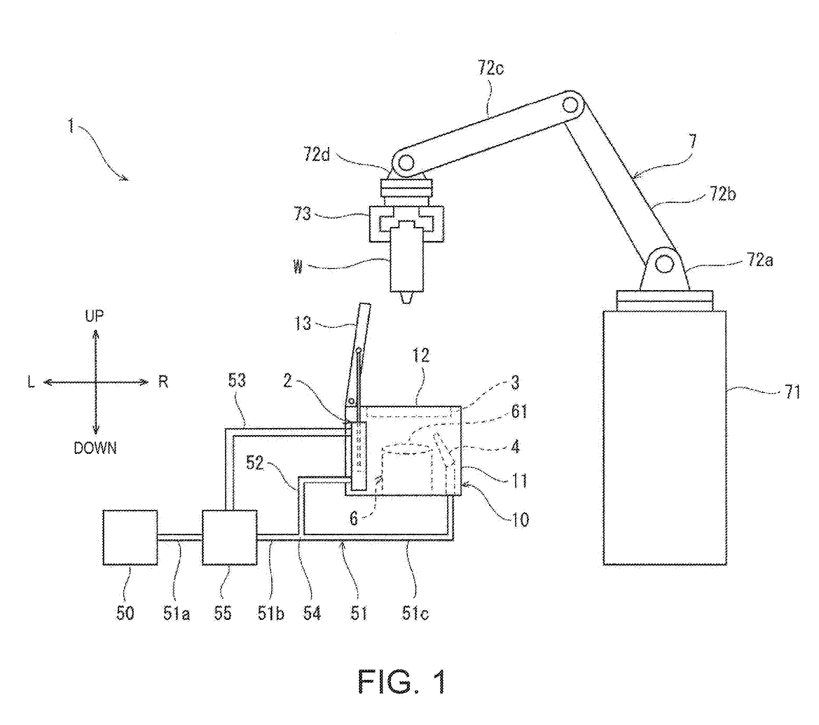

Hereinafter, a camera cover according to one embodiment of the present disclosure is described with reference to the accompanying drawings. FIG. 1 is a structural view schematically illustrating an imaging system 1 provided with a camera cover 10 according to this embodiment. The imaging system 1 is incorporated into a production line where products are manufactured and assembly of components etc. is conducted using an industrial articulated robot 7 in the production line.

The imaging system 1 includes an articulated robot 7 which grips a workpiece W, a camera unit 6 which images the workpiece W gripped by the articulated robot 7, and a camera cover 10 which accommodates a camera lens 61 of the camera unit 6. The articulated robot 7 includes a pedestal 71 fixed to a floor, an underframe, etc., a plurality of arms 72a-d, and a gripper 73 which grips the workpiece W. The plurality of arms 72a-d are serially coupled to each other so as to be rotatable with respect to adjacent arms. Moreover, the arm 72a at one end is rotatably coupled to the pedestal 71, while the arm 72d at the other end is rotatably coupled to the gripper 73.

The articulated robot 7 grips the workpiece W, which is a target of work, by the gripper 73, operates so that the workpiece W is conveyed to a main body component (not illustrated), and assembles the workpiece W to the main body component. In this assembly work, it is necessary to match topology of the workpiece W to assemble with topology of the main body component to be assembled. Thus, the imaging system 1 images the workpiece W by the camera unit 6 to detect the topology of the workpiece W based on acquired image information. The articulated robot 7 then adjusts the topology of the gripped workpiece W to the topology of the main body component based on the detected topology to assemble the workpiece W to the main body component.

In this embodiment, the camera unit 6 images from below the workpiece W which is gripped by the articulated robot 7 and is conveyed above the camera unit 6. The camera unit 6 has the camera lens 61 oriented upwardly. The camera lens 61 is accommodated in the camera cover 10 so that falling dust etc. does not adhere onto the lens of the camera. For example, the camera cover 10 is disposed outside an operating range of the articulated robot 7 in order to certainly prevent that the articulated robot 7 contacts the camera cover 10.

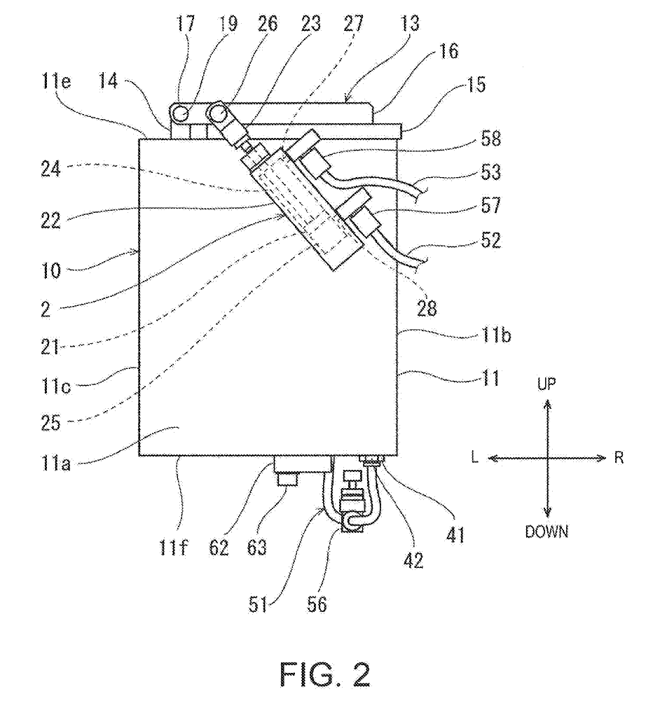

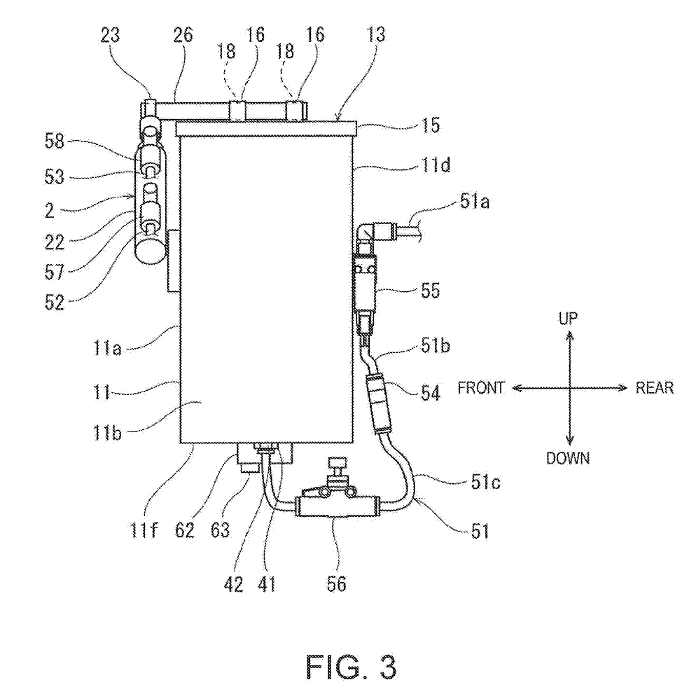

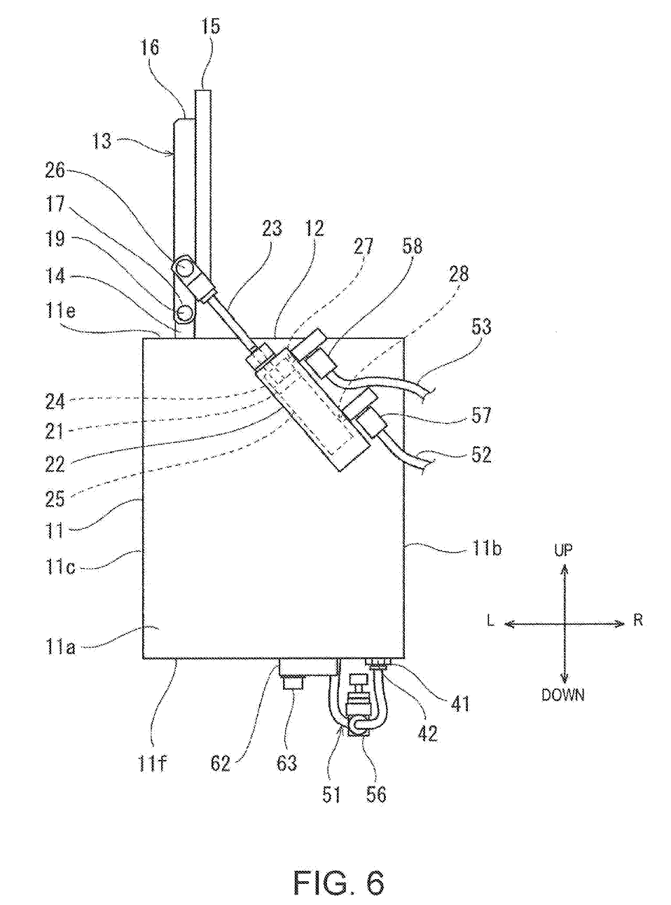

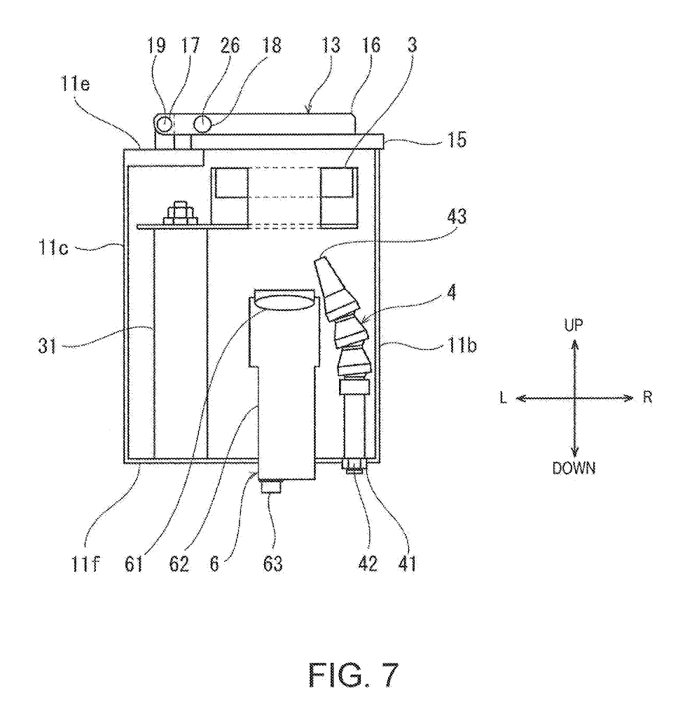

Next, a structure of the camera cover 10 is described with reference to FIGS. 2 to 7. FIGS. 2 to 5 are a partial front view, a partial right side view, a partial plan view, and a partial rear view of the camera cover 10, respectively. FIG. 2 illustrates a state where a lid body 13 of the camera cover 10 is at a closed position where the lid body 13 closes an opening 12, and FIG. 6 illustrates a state where the lid body 13 is at an open position where the lid body 13 opens the opening 12. FIG. 7 is a partial schematic cross-sectional view of the camera cover 10. Note that, in each drawing, part or all of, for example, components of first to third air channels 51-53 and the camera unit 6, and signal lines extending from a control valve 55, which are described below, are omitted for simplification.

The camera cover 10 includes a case 11 having the opening 12 which opens upwardly, and the lid body 13 attached to the case 11.

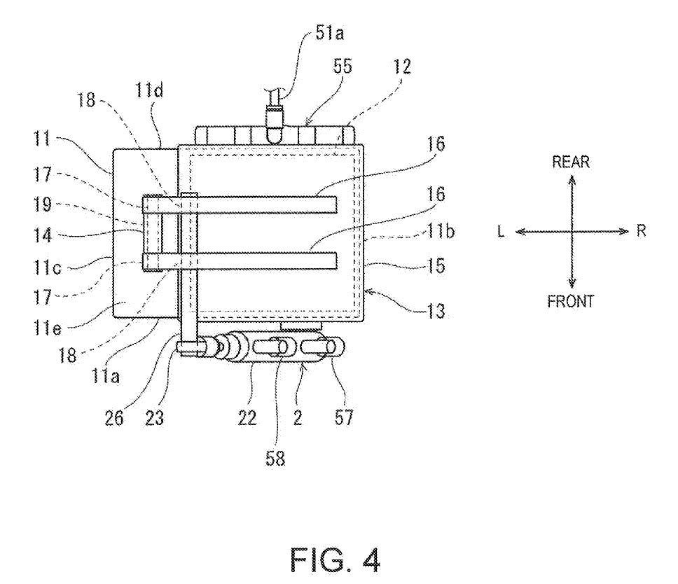

As illustrated in FIGS. 2 to 5, the case 11 forms an internal space for accommodating the camera lens 61, by a front wall 11a, a right side wall 11b, a left side wall 11c, a rear wall 11d, a top wall 11e, and a bottom wall 11f, which are substantially rectangular. As illustrated in FIG. 2, a lid body support part 14 for rotatably supporting the lid body 13 with respect to the case 11 via a rotating shaft 19 is provided so as to stand from an upper surface of the top wall 11e of the case 11. As illustrated in FIG. 4, the opening 12 is formed in a substantially rectangular shape by parts of an upper edge of the right side wall 11b, a right edge of the top wall 11e, and upper edges of the front wall 11a and the rear wall 11d.

The lid body 13 is constructed to be movable between the closed position (see FIG. 2) and the open position (see FIG. 6). As illustrated in FIG. 4, the lid body 13 includes a plate part 15 which closes the opening 12, and two plate support parts 16 fixed to an upper surface of the plate part 15. The plate part 15 has substantially the same shape as the opening 12 as seen in a plan view, when the lid body 13 is at the closed position. Each plate support part 16 has a square pole shape extending from the lid body support part 14 to the opening 12 when the lid body 13 is at the closed position. A first insertion hole 17 and a second insertion hole 18 are formed in each plate support part 16 in directions perpendicular to longitudinal directions, and the plate support part 16 is rotatably supported by the lid body support part 14 via the rotating shaft 19 passing through the first insertion holes 17.

As illustrated in FIG. 2, an air cylinder 2 is attached to the front wall 11a of the case 11, as a lid body moving mechanism which moves the lid body 13 between the open position and the closed position of the opening 12. The air cylinder 2 includes a cylinder part 22 having a piston 21 therein, and a piston rod 23 which is provided with the piston 21 at one end and transmits movement from the piston 21. The cylinder part 22 has an internal space where the piston 21 moves, and the internal space is divided by the piston 21 into a rod chamber 24 on the piston rod 23 side, and a head chamber 25 on the opposite side.

The piston rod 23 is coupled to the lid body 13 via a coupling shaft 26 passing through the second insertion holes 18 of the plate support parts 16, at a tip end on the opposite side of the piston 21. When the piston rod 23 reciprocates, the lid body 13 coupled to the piston rod 23 moves between the open position and the closed position. As illustrated in FIG. 2, air passing holes 27 and 28 for supplying and discharging air are formed in the rod chamber 24 and the head chamber 25, respectively. The piston rod 23 moves the lid body 13 from the open position to the closed position via the coupling shaft 26 by air being supplied to the rod chamber 24 from the air passing hole 27 (see FIG. 2). Moreover, the piston rod 23 moves the lid body 13 from the closed position to the open position via the coupling shaft 26 by air being supplied to the head chamber 25 from the air passing hole 28 (see FIG. 6).

With reference to FIG. 7, an internal structure of the case 11 of the camera cover 10 is described. Provided in the case 11 are the camera lens 61 described above, a lighting part 3 which irradiates light toward the workpiece W when the camera unit 6 images the workpiece W, and an air blow-off part 4 which blows off air upwardly when the lid body 13 is at the open position. The camera lens 61 is oriented toward the opening 12 of the case 11 so that the camera is capable of imaging through the opening 12 of the case 11.

The camera unit 6 includes the camera lens 61 oriented upwardly, a camera casing 62 which holds the camera lens 61, and an image sensor (not illustrated) which detects light introduced through the camera lens 61 and converts the light into an electrical signal. The camera casing 62 is fixed to the bottom wall 11f of the case 11 so that it penetrates the bottom wall 11f. The image information acquired by the image sensor of the camera unit 6 is sent to a control device (not illustrated) through the signal lines (not illustrated) extending from a connecting port 63 of the camera casing 62. The control device detects the topology of the workpiece W based on the sent information, and the detected topology information is used for the assembly work by the articulated robot 7.

Note that, although the camera unit 6 may have a plurality of camera lenses, not all the lenses need to be accommodated in the camera cover 10, The camera lens of the present disclosure in such a case refers to one of the plurality of lenses which the camera unit 6 has, which is disposed closest to the opening 12 through which the light first passes (top lens).

The lighting part 3 is supported by a lighting support base 31 fixed to the bottom wall 11f of the case 11. The lighting part 3 is oriented upwardly inside the case 11 between the camera lens 61 and the opening 12, for example. The lighting part 3 in this embodiment is a ring lighting device, and it is disposed so that the center axis of the ring lighting device matches with the optical axis of the camera lens 61.

An attaching part 41 for being attached to the bottom wall 11f is provided to one end of the air blow-off part 4 so that it penetrates the bottom wall 11f of the case 11, and an air supply port 42 is formed in the attaching part 41. The air supply port 42 is disposed outside the case 11. Air supplied to the air supply port 42 is blown off from an air blow-off port 43 formed in the other end of the air blow-off part 4.

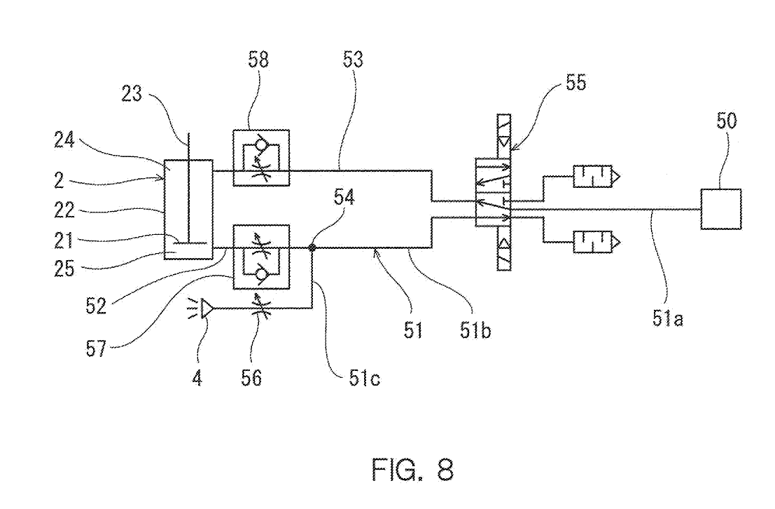

The supply of air to the air blow-off part 4 and the air cylinder 2 is described in more detail with reference to FIG. 8. FIG. 8 is an air circuit diagram illustrating the supply of air to the air blow-off part 4 of the camera cover 10. The camera cover 10 includes a first air channel 51 (an air channel of the present disclosure) which leads air from an air supply source 50 disposed outside the case 11 to the air blow-off part 4, and a second air channel 52 (a branched channel of the present disclosure) which branches from the first air channel 51 and leads air to the head chamber 25 of the air cylinder 2.

A control valve 55 which controls whether air is supplied to the air blow-off part 4 is provided to a portion of the first air channel 51 upstream of a branch point 54 of the second air channel 52 (the air supply source 50 side). In this embodiment, the control valve 55 is a two-position valve and is a five-port electromagnetic valve which moves between a first operating position (an upper position of FIG. 8) and a second operating position (a lower position of FIG. 8). One of two output ports of the control valve 55 is connected to a portion 51b of the first air channel 51 downstream of the control valve 55 (the air cylinder 2 side). The camera cover 10 includes a third air channel 53 which connects the other output port of the control valve 55 with the rod chamber 24 of the air cylinder 2.

When the control valve 55 is located at the first operating position, air supplied from the air supply source 50 passes through the control valve 55 and is supplied to the air blow-off part 4 through the first air channel 51, and at the same time, air is also supplied to the head chamber 25 of the air cylinder 2 through the second air channel 52. Thus, the piston rod 23 is operated to move the lid body 13 from the closed position to the open position. Here, the third air channel 53 connected to the rod chamber 24 of the air cylinder 2 is coupled to an exhaust port of the control valve 55 to release air to atmosphere.

On the other hand, when the control valve 55 is located at the second operating position, air supplied from the air supply source 50 passes through the control valve 55 and is supplied to the rod chamber 24 of the air cylinder 2 through the third air channel 53. Thus, the piston rod 23 operates and the lid body 13 moves from the open position to the closed position. Here, the portion 51b of the first air channel 51 downstream of the control valve 55 is coupled to the exhaust port of the control valve 55 to release air to atmosphere.

Thus, when the control valve 55 is shifted from the second operating position to the first operating position, the movement of the lid body 13 from the closed position to the open position and the blow-off of air from the air blow-off part 4 are performed simultaneously. Moreover, when the control valve 55 is shifted from the first operating position to the second operating position, the movement of the lid body 13 from the open position to the closed position and the stop of the blow-off of air from the air blow-off part 4 are performed simultaneously.

Note that a flow regulating valve 56 which adjusts a flow rate of air blown off from the air blow-off part 4 is provided to a portion 51c of the first air channel 51 downstream of the branch point 54. Moreover, flow regulating valves 57 and 58 which control air flow rate in order to adjust a speed of the piston rod 23 are provided to the second air channel 52 and the third air channel 53, respectively.

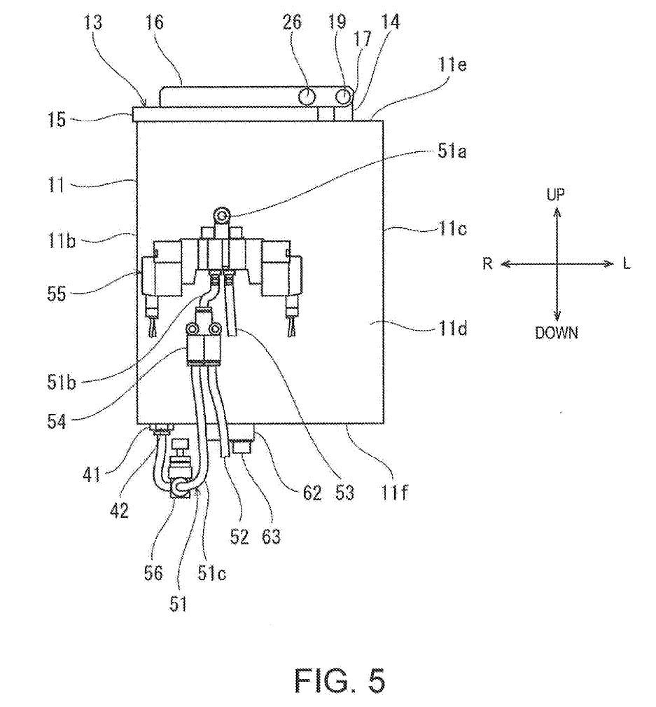

As illustrated in FIG. 5, the control valve 55 is attached to the rear wall 11d of the case 11, and the first to third air channels 51-53 are comprised of tubes etc. in this embodiment. Although omitted in FIG. 5, a tube corresponding to part of the second air channel 52 which extends from a connector for branch which constitutes the branch point 54 is coupled to the flow regulating valve 57 connected to the air passing hole 28 (see FIG. 2). Moreover, a tube corresponding to part of the third air channel 53 which extends from the control valve 55 is coupled to the flow regulating valve 58 connected to the air passing hole 27 (see FIG. 2).

Below, a flow of the assembly work of the workpiece W to the main body component in the production line provided with the imaging system 1 is illustratively described.

First, the articulated robot 7 grips the workpiece W which is a target of work by the gripper 73 and conveys the workpiece W above the camera cover 10.

When the workpiece W is placed above the camera cover 10, the control valve 55 is controlled to shift from the second operating position to the first operating position. Thus, air is supplied from the air supply source 50 to the air blow-off part 4 and to the head chamber 25 of the air cylinder 2, respectively. In this way, the air cylinder 2 operates to move the lid body 13 from the closed position to the open position, and air is blown off from the air blow-off part 4. While the lid body 13 is at the open position, air continues to be blown off from the air blow-off part 4.

When the lid body 13 is moved to the open position, the lighting part 3 is turned on to irradiate light and the workpiece W is imaged by the camera unit 6.

Once the imaging has been finished, the control valve 55 is controlled to shift from the first operating position to the second operating position. Thus, the supplies of air from the air supply source 50 to the air blow-off part 4 and to the head chamber 25 of the air cylinder 2 are stopped. In this way the air cylinder 2 operates to move the lid body 13 from the open position to the closed position, and the blow-off of air from the air blow-off part 4 is stopped.

The image information of the workpiece W imaged by the camera unit 6 is sent to the control device via the signal lines extending from the connecting port 63 of the camera casing 62, and the topology of the workpiece W is detected. Based on the detected topology information, the articulated robot 7 adjusts the topology of the gripped workpiece W to the topology of the main body component, and then conveys the workpiece W and assembles it to the main body component.

As described above, since the camera cover 10 of this embodiment prevents by the lid body 13 dust etc. from entering into the case 11 through the opening 12 when the lid body 13 is at the closed position, the dust etc. adhering onto the camera lens 61 accommodated in the camera cover 10 is prevented. In addition, when the lid body 13 is at the open position, air is blown off upwardly from the air blow-off part 4, i.e., from the inside of the case 11 toward the opening 12 of the case 11. Thus, even if the opening 12 is opened, the air blowing off from the air blow-off part 4 prevents dust etc. from entering into the case 11 and adhering onto the camera lens 61.

Moreover, in this embodiment, since the lid body 13 is rotatably attached to the case 11 and the air cylinder 2 moves the lid body 13 by being supplied with air from one of the open and closed positions to the other position, the opening-and-closing operation of the lid body 13 is achieved by a simple mechanism.

Furthermore, in this embodiment, air is led to the air cylinder 2 through the second air channel 52 which is branched from the first air channel 51 downstream of the control valve 55, and when the control valve 55 is controlled to start the supply of air to the air blow-off part 4, the air cylinder 2 moves the lid body 13 from the closed position to the open position, and when the control valve 55 is controlled to stop the supply of air to the air blow-off part 4, the air cylinder 2 moves the lid body 13 from the open position to the closed position. Thus, by controlling the control valve 55, the blow-off of air from the air blow-off part 4 and the opening-and-closing operation of the lid body 13 by the air cylinder 2 are interlocked. Therefore, the blow-off of air from the air blow-off part 4 when the lid body 13 is at the open position is achieved by the simple mechanism.

In the imaging system 1 of this embodiment, since it is possible to image the workpiece W from below while gripping the workpiece W by the articulated robot 7, and the camera cover 10 is located below the workpiece W, the articulated robot 7 does not need to avoid the camera cover 10 during the work. Thus, the work time of the articulated robot 7 is shortened.

The embodiment described above is illustration from every point of view and should be considered as nonrestrictive. The scope of the present disclosure is illustrated by not the above description but the appended claims, and is intended to include all changes within the meanings and scopes of the equivalents to the claims.

For example, the shapes and structures of the case 11 and the lid body 13, and the arrangements of the air cylinder 2 and the air blow-off part 4 are merely illustrations in the above embodiment, and the scope of the present disclosure is not limited to the structures. For example, the case 11 does not need to have the structure which is sealed when the lid body 13 is at the closed position, as long as it covers the camera lens 61 so as to avoid dust etc. adhering onto the camera lens 61. For example, part or all of the bottom wall 11f may be eliminated, and other parts of the case 11 may be partially eliminated. If the bottom wall 11f is eliminated, the air blow-off part 4, the camera lens 61, and the lighting part 3 may be supported in other manners. Moreover, although the camera cover 10, the camera lens 61 accommodated therein, etc. are illustrated so that imaging is performed vertically upwardly in the drawings, they are not limited to the structure. For example, they may constructed to image obliquely upwardly. Moreover, although the lid body 13 is rotatably attached to the case 11 in the above embodiment, the lid body 13 of the present disclosure may be a slide-type shutter structure, for example.

Moreover, the camera cover 10 may be structured, instead of having the third air channel 53, so that the air cylinder 2 is provided with a biasing member, and when the supply of air to the air cylinder 2 through the second air channel 52 is stopped, the piston 21 is moved toward the head chamber 25 by a biasing force of the biasing member. Moreover, although air is supplied to the air cylinder 2 from the second air channel 52 which is branched from the first air channel 51 in the above embodiment, air may be supplied to the air cylinder 2 and the air blow-off part 4 from a different air supply source. Moreover, although the air cylinder 2 is illustrated as the lid body moving mechanism in the above embodiment, the lid body moving mechanism of the present disclosure is not limited to this structure but may be another drive mechanism. In such a case, the opening-and-closing operation of the lid body 13 by the lid body moving mechanism and the blow-off of air from the air blow-off part may be controlled separately.

Moreover, although the case where the imaging system 1 of the present disclosure is applied to the assembly work by the articulated robot 7 in the above embodiment, the imaging system 1 is not limited to this application but may be applied to a system which inspects components and products, for example.

### DESCRIPTION OF REFERENCE CHARACTERS

1 Imaging System
10 Camera Cover
11 Case
12 Opening
13 Lid Body
2 Air Cylinder (Lid Body Moving Mechanism)
4 Air Blow-off Part
50 Air Supply Source
51 First Air Channel (Air Channel)
52 Second Air Channel (Branched Channel)
55 Control Valve
6 Camera
61 Camera Lens
7 Articulated Robot
W Workpiece

1. A camera cover configured to accommodate a camera lens, comprising:
a case having an opening that opens upwardly;
a lid body attached to the case;
a lid body moving mechanism configured to move the lid body between an open position at which the opening is opened and a closed position at which the opening is closed;
an air blow-off part provided in the case and configured to blow off air upwardly when the lid body is at the open position; and
an air channel configured to lead air from an air supply source disposed outside the case to the air blow-off part.

2. The camera cover of claim 1, wherein the lid body is rotatably attached to the case, and
wherein the lid body moving mechanism is an air cylinder configured to move the lid body by being supplied with air, from one of the open position and the closed position to the other position.

3. The camera cover of claim 1, further comprising:
a control valve provided to the air channel and configured to control supply of air from the air supply source to the air blow-off part; and
a branched channel that is branched from the air channel at a position downstream of the control valve and leads air to the lid body moving mechanism,
wherein the lid body moving mechanism is an air cylinder, the air cylinder being supplied with air through the branched channel when the control valve is controlled to start supply of air to the air blow-off part, and moving the lid body from the closed position to the open position, while the supply of air to the air cylinder through the branched channel being stopped when the control valve is controlled to stop the supply of air to the air blow-off part, and the air cylinder moving the lid body from the open position to the closed position.

4. An imaging system, comprising:
the camera cover of claim 1; and
a camera unit having the camera lens accommodated in the camera cover, and configured to image a workpiece located above the camera cover when the lid body is at the open position.

5. The imaging system of claim 4, further comprising an articulated robot configured to grip the workpiece.

6. The imaging system of claim 5, wherein the camera cover is disposed outside an operating range of the articulated robot.

7. The camera cover of claim 2, further comprising:
a control valve provided to the air channel and configured to control supply of air from the air supply source to the air blow-off part; and
a branched channel that is branched from the air channel at a position downstream of the control valve and leads air to the lid body moving mechanism,
wherein the lid body moving mechanism is an air cylinder, the air cylinder being supplied with air through the branched channel when the control valve is controlled to start supply of air to the air blow-off part, and moving the lid body from the closed position to the open position, while the supply of air to the air cylinder through the branched channel being stopped when the control valve is controlled to stop the supply of air to the air blow-off part, and the air cylinder moving the lid body from the open position to the closed position.

8. An imaging system, comprising:
the camera cover of claim 2; and
a camera unit having the camera lens accommodated in the camera cover, and configured to image a workpiece located above the camera cover when the lid body is at the open position.

9. An imaging system, comprising:
the camera cover of claim 3; and
a camera unit having the camera lens accommodated in the camera cover, and configured to image a workpiece located above the camera cover when the lid body is at the open position.

10. An imaging system, comprising:
the camera cover of claim 7; and
a camera unit having the camera lens accommodated in the camera cover, and configured to image a workpiece located above the camera cover when the lid body is at the open position.

11. The imaging system of claim 8, further comprising an articulated robot configured to grip the workpiece.

12. The imaging system of claim 9, further comprising an articulated robot configured to grip the workpiece.

13. The imaging system of claim 10, further comprising an articulated robot configured to grip the workpiece.

14. The imaging system of claim 11, wherein the camera cover is disposed outside an operating range of the articulated robot.

15. The imaging system of claim 12, wherein the camera cover is disposed outside an operating range of the articulated robot.

16. The imaging system of claim 13, wherein the camera cover is disposed outside an operating range of the articulated robot.
